(19) United States
(12) Patent Application Publication
(10) Pub. No.: US 2006/0091124 A1
(43) Pub. Date: May 4, 2006

(54) Method for transformation of color images into point arrangement for production of laser-induced color images inside transparent materials

(76) Inventors: Igor Troitski, Henderson, NV (US); Alexander Moroshkin, Moscow (RU); Andrey Shanturin, Moscow (RU)

Correspondence Address: IGOR TROITSKI, 853 ARROWHEAD TRAIL, HENDERSON, NV, 89015, US

(21) Appl. No.: 10/978,968

(22) Filed: Nov. 2, 2004

(51) Int. Cl. B23K 26/36

(52) U.S. Cl. 219/121.69

(57) ABSTRACT

The present invention disclose a method for transformation of images into arrangement of laser-induced images and location of these damages inside a transparent material so that it is possible to see right color images by illuminating the said transparent material by corresponding color light.

### FIELD OF THE INVENTION

The present invention relates to methods for producing laser-induced color images inside transparent materials by using pulsed laser radiation.

### BACKGROUND OF THE INVENTION

A number of techniques for creation of colored images on surfaces and inside transparent substrates by using natural light radiation and pulsed laser radiation are well known.

The Russian invention No. 321422 to Agadjanov, et al. discloses a method of manufacturing decorative products inside a transparent material by changing the material structure by laser radiation. As disclosed, by moving a material relative to a focused laser beam, it is possible to create a drawing inside the material.

U.S. Pat. No. 4,092,139 to Ference discloses a process for making colored photosensitive glass via the exposure thereof to high energy or actinic radiation followed by heat treatment thereof. The preferred embodiment of the method contemplates exposing the nucleated glass to high energy or actinic radiation while the glass is at an elevated temperature. Thus, the nuclead glass is developed while being exposed at a temperature between about 200. degree.-410. degree. C.

U.S. Pat. No. 4,295,872 to Luers discloses a method of producing an image of an original multi-color subject in polychromatic glass by employing as a masking means, during initial exposure of the glass, high contrast film positives embodying the subject in the form of half tone transparencies.

U.S. Pat. No. 4,302,235 to Luers discloses a method of producing an image of an original multi-color subject in polychromatic glass by employing, as mask during initial exposure of the glass, a continuous tone, ultra-violet transmitting, film negative in which each color in the original subject is recorded in terms of a unique film density corresponding to that color in the glass and capable of conditioning the glass for development of such color by transmission of a single predetermined exposure flux.

U.S. Pat. No. 4,328,299 to Beall, et al. discloses polychromatic glass articles and methods of producing such articles in which the glass is activated by exposure to ultraviolet radiation and contains as a sensitizing agent an oxide of copper, samarium, terbium, praseodymium, or europium.

U.S. Pat. No. 4,467,172 to Ehrenwald et al. discoses the method and apparatus for laser engraving diamonds with permanent identification markings. A shallow penetration depth and narrow line width is achieved by using a harmonic conversion device to produce an output frequency which is second harmonic of the fundamental laser frequency in combination with a lens system having a short focal length to provide a high density pinpoint spot of laser energy.

U.S. Pat. No. 4,514,053 to Borrelli, et al. discloses an integral optical device that is composed of a photosensitive glass having an optical pattern developed therein by a refractive index change due to formation of colloidal metal particles and/or crystalline microphases nucleated by such particles. In a specific embodiment the pattern is composed of at least one transparent lens system having a radial gradient refractive index distribution of prescribed nature.

U.S. Pat. No. 4,843,207 to Urbanek et al. discloses a method of creating controlled decorations on the surface of a hollow symmetrical transparent article. This technique is preferably carried out on glass. The glass is preconditioned with a coating on the outer surface of the glass being approximately 1.2 mm thick and made of a material having at least 75% absorption of laser radiation. The technique is also carried out using a laser having a wave of length of 0.5 to 2 microns acting upon the external coating through the wall of the cylindrical glass article. The laser beam moves so that it is focused on the surface of the cylinder, and moves about the axis of symmetry of the cylinder to irradiate the aforementioned surface coating. As a result, the irradiated portions of the surface coating go through a phase change and a pattern is formed.

U.S. Pat. No. 5,019,538 to Borrelli, et al. discloses a method of production of photosensitive opal lasses which, through an exposure to ultraviolet radiation, followed by a three-step heat treatment, and then a re-exposure to ultraviolet radiation at an elevated temperature, can be converted into a colored opal glass.

U.S. Pat. No. 5,206,496 to Clement et al. discloses a method and apparatus for providing in a transparent material, such as glass or plastic, a mark which is visible to the naked eye or which may be “seen” by optical instruments operating at an appropriate wavelength. The Clement et al. patent describes a method and apparatus for producing a subsurface marking which is produced in a body such as bottle, by directing into the body a high energy density beam and bringing the beam to focus at a location spaced from the surface, so as to cause localized ionization of the material. In the preferred embodiment the apparatus includes a laser as the high energy density beam source. The laser may be a Nd—YAG laser that emits a pulsed beam of laser radiation with a wavelength of 1064 nm. The pulsed beam is incident upon a first mirror that directs the beam through a beam expander and a beam combiner to a second mirror. A second source of laser radiation in the form of a low power He—Ne laser emits a secondary beam of visible laser radiation with a wavelength of 638 m. The secondary beam impinges upon the beam combiner where it is reflected toward the second reflecting surface coincident with the pulsed beam of laser radiation from the Nd—YAG laser. The combined coincident beams are reflected at the reflecting surface via reflecting two other surfaces to a pair of movable mirrors for controlling movement of the beam. The beam then passes through a lens assembly into the body to be marked.

WIPO Patent Document No. 96/30219 to Lebedev discloses a technology for creating two- or three-dimensional images inside a polymer material using penetrating electromagnetic radiation. The technology can be used for marking and for producing decorative articles and souvenirs. Specifically, laser radiation is used as the penetrating radiation, and carbonizing polymers are used as the polymer material. By these means, it is possible to produce both black and half-tone images in the articles.

U.S. Pat. No. 5,575,936 to Goldfarb discloses a process and apparatus where a focused laser beam causes local destruction within a solid article, without effecting the surface thereof The apparatus for etching an image within a solid article includes a laser focused to a focal point within the article. The position of the article with respect to the focal point is varied. Control means, coupled to the laser, and positioning means are provided for firing the laser so that a local disruption occurs within the article to form the image within the article.

U.S. Pat. No. 5,637,244 to Erokhin discloses a technique which depends on a particular optical system including a diffraction limited Q-switched laser (preferably a solid-state single-mode TEM₀₀) aimed into a defocusing lens having a variable focal length to control the light impinging on a subsequent focusing lens that refocuses the laser beam onto the transparent article being etched. The laser power level, operation of the defocusing lens, and the movement of the transparent article being etched are all controlled by a computer. The computer operates to reproduce a pre-programmed three-dimensional image inside the transparent article being etched. In the computer memory, the image is presented as arrays of picture elements on various parallel planes. The optical system is controlled to reproduce the stored arrays of picture elements inside the transparent material. A method for forming a predetermined half-tone image is disclosed. Accordance to the method, microdestructions of a first size are created to form a first portion of the image and microdestruction of a second size different from the first size are created to form a second portion of the image. Different sizes of microdestructions are created by changing the laser beam focusing sharpness and the radiation power thereof before each shot.

U.S. Pat. No. 5,653,900 to Clement, et al. discloses a method and an apparatus for making a moving body of material. In a preferred embodiment, the apparatus includes at least one movable galvanometer mirror capable of moving the laser beam to create a mark of a predetermined shape.

U.S. Pat. No. 5,656,186 to Mourou, et al. discloses a method for controlling configuration of laser induced breakdown and ablation. The method comprises generating a beam of laser pulses in which each pulse has a pulse width equal to or less than the predetermined laser pulse width value. The beam is focused to a point at or beneath the surface of a material where laser induced breakdown is desired. The technique can produce features smaller than the spot size and Rayleigh range due to enhanced damage threshold accuracy in the short pulse regime.

U.S. Pat. No. 5,786,560 to Tatah et al. discloses a method of treating a material by generating an ultraviolet wavelength laser beam having femtosecond pulses; splitting the laser beam into a plurality of separate laser beams; directing these laser beams onto a target point within a sample such that the beams overlap to create an intensity sufficient to treat the sample.

U.S. Pat. No. 5,886,318 to A. Vasiliev and B. Goldfarb discloses a method for laser-assisted image formation in transparent specimens, which consists in establishing a laser beam having different angular divergence values in two mutually square planes. An angle between the plane with a maximum laser beam angular divergence and the surface of the image portion being formed is changed to suit the required contrast of an image.

EPO Patent Document 0743128 to Balickas et al. disclose a method of marking products made of transparent materials which involves concentration of a laser beam in the material which does not absorb the beam, at a predetermined location, destruction of the material by laser pulses and formation of the marking symbol by displacement of the laser beam. Destruction of the material at that location takes place in two stages. In the first stage, the resistance of the material to laser radiation is altered, while, in the second stage, destruction of the material takes place at that location.

Russian patent publication RU 20082288 to S. V. Oshemkov discloses a process for laser forming of images in solid media by the way of focusing of laser radiation in a point inside a sample which differs by following: with the aim to save the surface and the volume of the sample before the definite point and creation of three dimensional images, the sample is illuminated with the power density higher than the threshold of volume breakdown and moving the sample relatively to the laser beam in three orthogonal directions.

U.S. Pat. No. 6,087,617 to Troitski et al. discloses a computer graphic system for producing an image inside optically transparent material. An image reproducible inside optically transparent material by the system is defined by potential etch points, in which the breakdowns required to create the image in the selected optically transparent material are possible. The potential etch points are generated based on the characteristics of the selected optically transparent material. If the number of the potential etch points exceeds a predetermined number, the system carries out an optimization routine that allows the number of the generated etch points to be reduced based on their size. To prevent the distortion of the reproduced image due to the refraction of the optically transparent material, the coordinates of the generated etch points are adjusted to correct their positions along a selected laser beam direction.

U.S. Pat. No. 6,333,485 to Haight, et al. discloses a method for minimizing sample damage during the ablation of material using a focused ultra short pulse beam. The beam is focused above the surface of a material where laser induced breakdown is desired. The region of least confusion (minimum beam waist or average spot size) is above the surface of the material in which laser induced breakdown is desired since the intensity of the beam falls in the forward direction.

U.S. Pat. No. 6,333,486 to Troitski discloses method and laser system for creation of laser-induced damages to produce high quality images. Accordance to the invention, a laser-induced damage is produced by simultaneously generating breakdowns in several separate focused small points inside the transparent material area corresponding to this etch point. Damage brightness is controlled by variation of a number of separate focused small points inside the transparent material area.

U.S. Pat. No. 6,392,683 to Hayashi discloses method for making marks in a transparent material by using a laser. A laser beam of a wavelength that is transmitted by the material from which this object to be marked is formed is focused on the inner portion of said object to be marked, using lens. A mark is formed in the region of the object to be marked where the laser beam is focused.

U.S. Pat. No. 6,399,914 to Troitski discloses methods and an apparatus for creating high quality laser-induced damage images. One or more embodiments of the invention comprise a method for producing laser-induced damage images inside the special transparent material containing special kinds of impurities, which decrease the damage threshold of the material. Colored laser-induced damage images are produced inside transparent materials containing color impurities. Laser radiation is focused inside the transparent material in such a way that focal area contains at least one said impurity. Other embodiments of the invention comprise a method and a system for producing laser-induced images by using two lasers. The first laser generates radiation, which heats the predetermined material area about a point, where breakdown should be produced, to the vitrify temperature. The second laser generates radiation, which creates breakdown in a point of the heated area after the area is heated to the vitrify temperature.

U.S. Pat. No. 6,417,485 to Troitski discloses method and laser system controlling breakdown process development and space structure of laser radiation for production of high quality laser-induced damage images. Accordance to the invention, at the beginning an applied laser radiation level just exceeds an energy threshold for creating a plasma condition in the material, and thereafter the energy level of the applied laser radiation is just maintain the plasma condition. Accordance to another method a laser generates a TEMₘₙ radiation. The values of the integers m and n are controlled and determined so as to reproduce particular gray shades for a particular point of an image.

U.S. Pat. No. 6,426,480 to Troitski discloses a method and laser system for production of high quality single-layer laser-induced damage portraits inside transparent material.

U.S. Pat. No. 6,490,299 to Raevsky et al. discloses a method and laser system for generating laser radiation of specific temporal shape for production of high quality laser-induced damage images.

U.S. Pat. No. 6,509,548 to Troitski discloses a method and laser system for production of high-resolution laser-induced damage images inside transparent materials by generating small etch points.

U.S. Pat. No. 6,566,626 to Gaissinsky, et al. discloses a method and apparatus for generating colored image of at least one color within a light-sensitive glass sample. The glass sample contains light-sensitive chemical components that acquire at least one of a multiplicity of colors in response to actinic radiation and subsequent heating to a temperature that causes color to appear. The method comprises focusing a pulsed laser beam to a target location within the glass, irradiating a plurality of pulses focused in the target location within the glass sample, thus generating a zone of increased opacity to the visible light at the target location and a resultant location actinic radiation at that zone, displacing the focus point of the laser beam and the glass sample relative to each other by the displacing device in a predetermined manner so as to produce a plurality of zone of increased opacity that form an image, and heating of the sample to a temperature that causes color to appear at the zone of increased opacity.

U.S. Pat. No. 6,605,797 to Troitski discloses a laser-computer graphics system for producing images such as portraits and 3-D sculptures formed from etch points inside an optically transparent material.

U.S. Pat. No. 6,630,644 to Troitski et al. discloses a method creating damage arrangement for production of 3D laser-induced damage portraits inside transparent materials.

U.S. Pat. No. 6,664,501 to Troitski discloses a method for creating laser-induced color images within three-dimensional transparent media, particularly inside the photosensitive glass. The latent image is created by focusing of IK ultra short laser pulsed radiation into separate areas of the photosensitive glass, so as focal spot sizes are approximately equal to the resolution element of the created image. The latent image is developed to the visible image by focusing of laser pulses at points of the latent image.

U.S. Pat. No. 6,670,576 to Troitski et al. discloses a method for producing images containing laser-induced color centers and laser-induced damages. The method is based on two physical phenomenon: photoionization and laser-induced breakdown.

U.S. Pat. No. 6,720,521 to Troitski discloses a method for production laser-induced images in which at the beginning an applied laser radiation level just exceeds an energy threshold for creating a plasma condition in the material, and thereafter the energy level of the applied laser radiation is just maintain the plasma condition and is applied before the plasma condition extinguishes, but after a shock wave associated therewith has passed.

U.S. Pat. No. 6,720,523 to Troitski discloses a method for production of laser-induced images represented by incomplete data, which are supplemented during production.

U.S. Pat. No. 6,727,460 to Troitski discloses a system for high-speed production of high quality laser-induced damage images inside transparent materials.

U.S. Pat. No. 6,734,389 to Troitski discloses a method and laser system for producing etch points without star structure by control of breakdown process development.

U.S. Pat. No. 6,740,846 to Troitski, et al. discloses a method for production of 3D laser-induced head image inside transparent material by using several 2D portraits.

U.S. Pat. No. 6,768,080 to Troitski discloses a method for production of laser-induced damage images, which are able to change their optical characteristics depending on bopresight allocation and which are looked like iridescent images laying out white light incident upon them.

U.S. Pat. No. 6,768,081 to Troitski discloses a method and laser system for production of high quality laser-induced damage images by using material processing made before and after image creation.

The publication “Laser-induced damage creates interior images” (Troitski, OE Report, No. 191, November 1999) described the general principals creation of laser-induced images.

The publication “System for creation of laser-induced damage images and problems of their optimization” (I. N. Troitski, Proc. of SPIE Vol. 3902 (2000), 489-499) describes methods for generating 3D images and portraits allowing reproduction of them within an optically transparent material with the same resolution like computer images, without sharp point structure and without significant fluctuation of gray shades.

The publication “Experience of creation of laser-induced damage images” (I. N. Troitski, Proc. of SPIE Vol. 3902 (2000), 479-488) discloses the specific system for production of laser-induced damage images.

The publication “Image recording by laser-induced damages” (I. N. Troitski, Optical Memory and Neural Networks, Vol. 9, No. 4, (2000) 233-238) discusses the problems of laser-induced damage utilization for image recording.

The publication “Method and laser system for creating high-resolution laser-induced damage images” (I. N. Troitski, Proc. of SPIE Vol. 4679 (2002), 392-399) describes creation of small laser-induced damages without large star structure by the specific temporal radiation.

All patents and publications describe the methods and systems for creation of marks for production of both regular and color laser-induced images but do not disclose methods and system for transformation of images into arrangement of points for producing color laser-induced images inside transparent materials. The purpose of the invention is to disclose such methods and systems.

### SUMMARY OF THE INVENTION

The present invention has its principal task to provide a method for transformation of images into arrangement of laser-induced damages and location of these damages inside a transparent material so that it is possible to see color images by illuminating the said transparent material by corresponding color light.

One or more embodiments of the invention comprise a method for transformation of color image into point arrangements containing several point groups, each of which consists of points of the same hue and saturation so that the points of each said group can be illuminated by the external light of the same color.

Another embodiment of the invention comprises a method for transformation of color image into point arrangement corresponding to the given color model, so that laser-induced damages, which are produced inside photosensitive glasses and which have pure colors, reproduce the right color images.

One or more embodiments of the invention comprise a method and a system for color illumination of a transparent material by using effect of total internal refraction so that the external color light is scattered by only laser-induced damages.

### DESCRIPTION OF THE DRAWINGS

FIG. 1 shows the location of laser-induced damages of a small area of a laser-induced image inside layers of a transparent material: number 1 marks damages of the left layer; number 2 marks damages of the middle layer; mark 3 marks damages of the right layer; red, green, and blue are color beams illuminating the left, middle and right layers correspondingly.

FIG. 2 shows illumination of a flat plate of transparent material; external light is directed into the material so that the angle of its incidence is equal to the critical angle; a damage becomes visible as a result of scattering of the beam, which meets the damage.

### DETAILED DESCRIPTION OF THE INVENTION

The invention comprises the method and system for transformation of images into arrangement of points to produce laser-induced color images inside optically transparent materials. In general, the invention relates to methods, in which laser energy is utilized to generate laser-induced marks at the points of transparent materials, using the physical phenomenon accompanying the interaction of power laser radiation with the transparent material.

The opportunity creating three dimensional colored laser-induced images inside transparent materials was noted in “Laser-induced damage creates interior images” (OE Report, No 191, November 1999). Today, it is possible to formulate five ways, which provide the production of colored laser-induced images by:
1) creating color centers generated on the base of the photo ionization (U.S. Pat. No. 6,670,576 to Troitski et al.);
2) creating laser-induced damages of the special space shapes (U.S. Pat. No. 6,768,080 to Troitski);
3) creating regular laser-induced damages produced inside photosensitive glass (U.S. Pat. No. 6,566,626 to Gaissinsky et al.);
4) creating latent image inside the photosensitive glasses by special physical effects of laser radiation interaction with transparent materials (U.S. Pat. No. 6,664,501 to Troitski);
5) transformation of image into arrangement of etch points and location of the points inside transparent material so that it is possible to see right color image by illuminating the etch points by corresponding color light.

The present invention relates to number five way and discloses methods of special image transformation into point arrangements, location of the points inside transparent materials, and their illumination by external color light.

The reason of creating these new methods for production of colored laser-induced images is stimulated by removing disadvantages peculiar to methods listed above. For example, laser-induced images containing color centers generated by the photo ionization disappear with time. Laser-induced images containing laser-induced damages of special space shape are rainbow images and they do not provide needed color of different image areas. Production of 3D color laser-induced images by creating breakdowns inside photosensitive glasses is a difficult task because it is practically impossible to reproduce a lot of different color hues by controlling laser energy.

One or more embodiments of the invention comprise a method for transforming color images into arrangement of points by using standard color models and positioning the points inside transparent material so that laser-induced damages produced at the points being illuminated by external light of corresponding color reproduce the right color images. This method includes the following steps:

Step 1. Transformation of a color image into the first point arrangement by using one of the standard color models.

Step 2. Transformation of the first point arrangement into the second point arrangement containing several point groups, each of which consists of points of the same hue and saturation.

Step 3. Transformation of the second point arrangement into the third point arrangement so that the points of each said group can be illuminated by the external light of the same color.

Step 4. Transformation of the third point arrangement into the fourth point arrangement so that laser-induced breakdowns can be produced at the points of the fourth point arrangement without internal crash of the transparent material.

To explain the general ideas of the method and its steps, let us suppose that we should produce a 2D color laser-induced image inside a transparent material. For definition, we use RGB color model. In this case any color image is reproduced by varying the intensity of red, green, and blue light. Therefore, we can define colors by specifying the intensity of the red, green, and blue components. A laser-induced damage of a regular transparent material is a mark which scatters an external light. Consequently, illuminating a laser-induced damage by the red, green and blue beams of the right intensities, it is possible to see the said damage of needed color. As a result, the needed color laser-induced image can be reproduced by illuminating every damage by corresponding combination of the red, green, and blue beams.

To illuminate every laser-induced damage by special color light is reasonable only in case of low resolution, when little number of points is used for reproduction of the color image. In case of high resolution, it is reasonable to unify a number of damages by division of the image area into several small compact areas, each containing damages of the same color. For RGB color model, all damages of each small area are unified into three groups: the first concludes the damages which are illuminated by the red color; the second contains the damages which are illuminated by the green color; and the third group consists of the damages which are illuminated by blue color. It is possible, varying the number of damages of each group and the sizes of these damages, to control the intensities of the red, green and blue color scattered by the small area and as a result of this, to create needed integral color light reflected by the small image area. In other words, by using this method it is possible to create color laser-induced images by creating necessary colors of separated small areas of this image.

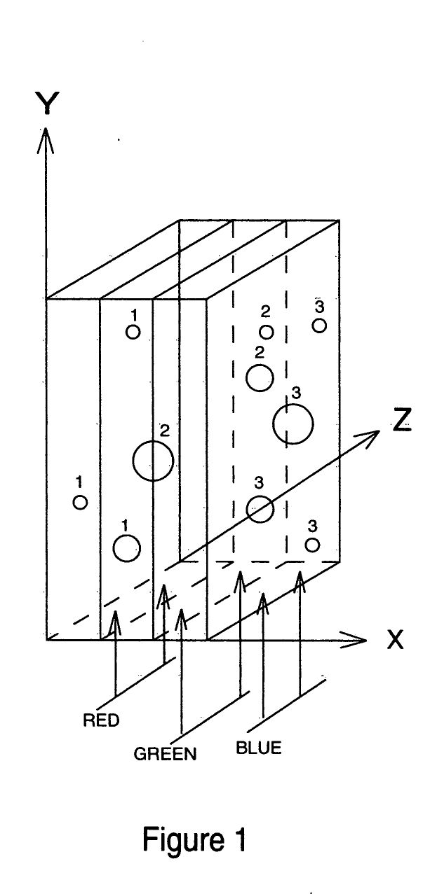

After determining the groups of damages, which should be illuminated by the light of necessary color, the next very important task is to arrange all laser-induced damages so that they can be really illuminated in the needed way. Reference is now made to FIG. 1 showing location of laser-induced damages of a small area. We see that the damages are located inside several (three) layers of a transparent materials so that damages of the first group are located in the first layer, damages of the second group are located in the second layer, and damages of the third group are located in the third layer. All these damages are arranged so that one does not shade another and so that internal crash of the transparent material cannot arise. The first layer is illuminated by the red light, the second layer is illuminated by the green light, and the third layer is illuminated by the blue light. The number of damages and their sizes are determined so that the combination of red, blue, and green intensities creates necessary color of this small area.

The next task is to arrange all damages of the same layer that they do not shade each other. Taking into account that each layer has sizes along three axes X,Y,Z, it is possible to control the values of these sizes (in particular, size along X) to satisfy this condition. Another way is production of special multilayer transparent material so that every layer is similar to an optical fiber.

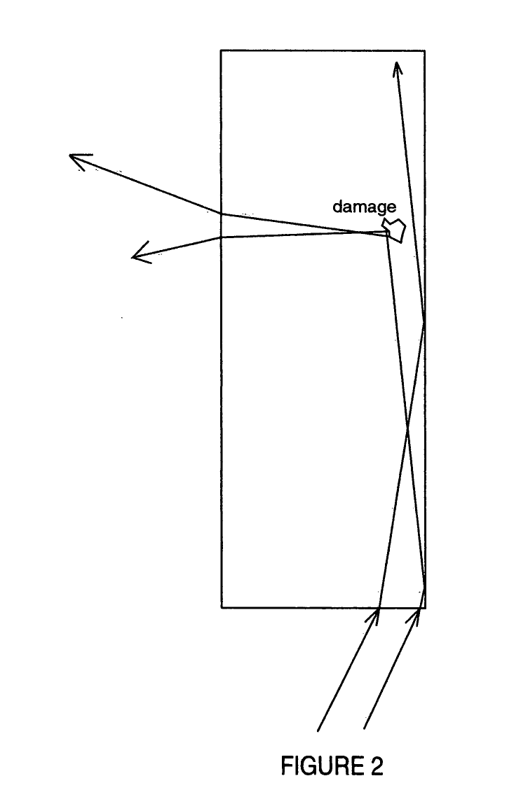

One or more embodiments of the invention comprise a method for illuminating laser-induced damages of transparent material by using effect of total internal refraction. For this, external light is directed into flat plate of transparent material so that the angle of its incidence is not smaller than critical angle. In this case the light wave penetrates into the external medium to a distance of the order of a wavelength and then returns to the first medium. However, if the light meets a laser-induced damage, it is scattered by this damage and goes out from the material. As a result a laser-induced damage becomes visible and has color of illuminated light. This effect is illustrated by FIG. 2. Hence, using transparent material containing several layers, each inabled to provide total internal refraction of illuminated light, it is possible to produce damages inside these layers which being illuminated by necessary color light reproduce right color image.

Another aspect of the invention is a system for color illuminating laser-induced damage images comprising:
light source for generating at least one color beam;
optical system for transferring the said beams into narrow beams so as they are able to illuminate predetermined areas of a transparent material;
system for directing the said beams into predetermined areas of the transparent material so as the beams illuminate the said predetermined areas.

In particularly, an optical system of FIG. 1 transforming laser beams should contains cylindrical lens and a system for directing beams into flat plate of transparent material so that the angle of its incident is equal to the critical angle should have controlled deflector device.

Thus, a method for transformation of an image into arrangement of points to produce laser-induced color image inside transparent material is as follows:
Transformation of a color image into the first arrangement of points, which correspond to the pixels of the said image.
Definition of color which should have each point in accordance with the given color model for reproduction of the said color image.
Definition of sizes which should have the laser-induced damage corresponding to the color point so as the light scattered by the point has necessary intensity.
Transformation of the first point arrangement into the second point arrangement containing several point groups, each of which consists of points of the same hue and saturation.
Controlling a place for each point of the said group inside transparent material so that one does not shade another.
Transformation of the second point arrangement into the third point arrangement so that the points of each said group can be illuminated by the external light of the same color.
Transformation of the third point arrangement into the fourth point arrangement so as laser-induced breakdowns can be produced at the points of the fourth point arrangement without internal crash of the transparent material.

In case of high resolution, a method for transformation of an image into arrangement of points for production of laser-induced color image inside transparent material comprises the following steps:
Separation of an image area into several small compact areas, containing pixels of the same color.
Definition of a number of laser-induced damages and their sizes so that the light scattered by them creates necessary hue and saturation of the said areas.
Unifying damages of said areas into several groups corresponding to the number of colors of used color models.
Placing each damage of the said group inside transparent material so one does not shade another and so that the damages of each said group can be illuminated by the external light of the same color.
Controlling placement of damages inside the transparent material so that laser-induced breakdowns creating these damages can be produced without internal crash of the transparent material.

We described the method for transformation of an image into arrangement of damages for producing laser-induced color image inside regular transparent material. This method can be modernized for special transparent materials, which are used to print colored photographic images within glass articles. One of the three-dimensional photographic media, which makes it possible, is photosensitive glass (Kurt Nassau “The physics and chemistry of color”, A Wiley-Interscience Publication, 2001, pp 307-308). Photosensitive glasses are very similar to certain conventional glasses in composition, except for minute additions of constitution that may be classified as photosensitive metals, optical sensitizers and thermoreducing agents. Methods for creating laser-induced images inside these transparent materials are disclosed in U.S. Pat. No. 6,566,626 to Gaissinsky, et al. and U.S. Pat. No. 6,664,501. Both these methods have the same problem connected with creation of necessary color damage by controlling the intensity of laser radiation. That is the only part of laser energy, which is used for generating UV radiation necessary for producing color mark inside the glasses, is responsible for hue and saturation of this laser-induced mark. Another part of the laser energy connects with other physical phenomenon, accompanying the interaction of laser radiation with the transparent material. As a result, it is very difficult to estimate what part of the total laser energy is used for creating color mark and therefore controlling the intensity of laser radiation gives a chance to reproduce only approximate value of hue and saturation.

The use of preliminary transformation of color images into arrangement of color points permits to correct the situation described above. In this case it is not necessary to reproduce exact values of hue of each mark but it is enough to produce marks of pure color corresponding to the used color model. The necessary hue and saturation of different image areas are created by controlling the number of marks of the areas and the sizes of the marks. Thus, in this case, only several values of laser intensity, corresponding to the number of colors of given color model should be defined and controlled. For example, the use of RGB color model demands definition of only three values of the said intensity corresponding to red, green and blue colors.

A method for transformation of an image into arrangement of points for production of laser-induced color image inside glass sample containing light-sensitive chemical components comprises the following steps:

Step 1. Transformation of a color image into the first point arrangement corresponding to the pixels of the said image.

Step 2. Transformation of the first point arrangement into the second point arrangement containing several point groups and satisfying the following conditions: the first—each group contains at least one point; the second—all points has only pure color, corresponding to the given color model; the third—all points of each group create hue and saturation corresponding the image area, containing the points of the said group.

Step 3 Transformation of the second point arrangement into the third point arrangement so that laser-induced breakdowns can be produced at the points of the third point arrangement without internal crash of the transparent material.

We claim:

1. A method for transformation of color images into point arrangement for production of color laser-induced images inside transparent materials comprising:
Transformation of a color image into the first point arrangement by using one of the standard color models.
Transformation of the first point arrangement into the second point arrangement containing several point groups, each consisting of points of the same hue and saturation.
Transformation of the second point arrangement into the third point arrangement so that the points of each said group can be illuminated by the external light of the same hue and saturation.
Transformation of the third point arrangement into the fourth point arrangement so that laser-induced breakdowns can be produced at the points of the fourth point arrangement without internal crash of the transparent material.

2. The method in accordance with claim 1 wherein the said color image is transformed into arrangement of points corresponding to the points of transparent material where laser-induced damage should be produced.

3. The method in accordance with claim 1 wherein the color which should have each point in accordance with the given color model for reproduction of the said color image is determined.

4. The method in accordance with claim 1 wherein the sizes which should have the laser-induced damage corresponding to the color point are determined so as the light scattered by the point has necessary intensity.

5. The method in accordance with claim 1 wherein all points of the said images are unified into the several point groups, each consisting of points of the same hue and saturation.

6. The method in accordance with claim 1 wherein a place for each point of the said group inside transparent material is controlled so that no point shades another.

7. The method in accordance with claim 1 wherein the said points are placed inside the transparent material so that the points of each said group can be illuminated by the external light of the same color.

8. The method in accordance with claim 1 wherein the image area is separated into several small compact areas, so that the each said small area contains pixels of the same color.

9. The method in accordance with claim 1 wherein the number of laser-induced damages and their sizes are determined so that the light scattered by these damages creates necessary hue and saturation of the said areas.

10. The method in accordance with claim 1 wherein the damages of the said areas are unified into several groups corresponding to the number of colors of used color models.

11. A method for transformation of color images into point arrangement for production of color laser-induced images inside photosensitive transparent materials comprising:
Step 1. Transformation of a color image into the first point arrangement corresponding to the pixels of the said image.
Step 2. Transformation of the first point arrangement into the second point arrangement containing several point groups and satisfying the following conditions, the first—each group contains at least one point; the second—all points has only pure color, corresponding to the given color model; the third—all points of each group create hue and saturation corresponding to the image area, containing the points of the said group.
Step 3 Transformation of the second point arrangement into the third point arrangement so that laser-induced breakdowns can be produced at the points of the fourth point arrangement without internal crash of the transparent material.

12. A system for illumination of the laser-induced images comprising:
A light source for generating at least one color beam.
An optical system for transferring the said beams into beams which are able to illuminate predetermined areas of a transparent material.
A system for directing the said beams into predetermined areas of the transparent material so that the beams illuminate the said predetermined areas.

13. An optical system in accordance with claim 12 wherein transformation of laser beams into narrow beams provides by cylindrical lens.

14. A system in accordance with claim 12 wherein directing the said beam into a transparent material is provided so that the angle of its incident on internal surface of the said material is equal to the critical angle corresponding to total internal refraction.
